(19) United States
(12) Patent Application Publication
(10) Pub. No.: US 2025/0374909 A1
(43) Pub. Date: Dec. 11, 2025

(54) APPARATUS, SYSTEMS, AND METHODS TO MANAGE VEGETATION ALONG A RIGHT-OF-WAY

(71) Applicant: Marathon Petroleum Company LP, Findlay, OH (US)

(72) Inventors: Julia N. Beaschler, Findlay, OH (US); Scott W. Sharpe, Findlay, OH (US)

(21) Appl. No.: 19/226,818

(22) Filed: Jun. 3, 2025

Related U.S. Application Data
(60) Provisional application No. 63/657,875, filed on Jun. 9, 2024.
(60) Provisional application No. 63/733,338, filed on Dec. 12, 2024.

(51) Int. Cl. A01M 21/00; G01S 17/89; G06F 3/048; G06V 20/10; G06V 20/17

(52) U.S. Cl. CPC A01M 21/00; G01S 17/89; G06F 3/048; G06V 20/17; G06V 20/176; G06V 20/188; G06V 2201/10

(57) ABSTRACT

Embodiments of systems and methods to enhance vegetation control along an underground feature right-of-way are disclosed. In an embodiment, the method may include receiving data from one or more sources. The method may include generating, based on location data in the data, a plurality of right-of-way representations for a graphical user interface (GUI). The method may include correlating the data from the one or more sources to a corresponding right-of-way point. The method may include storing the data as metadata associated with the corresponding right-of-way. The method may include determining an event occurrence based on image data in the data from one or more of an image capture aerial vehicle or one or more computing devices. The method may include determining a next action for the plurality of right-of-way points based on one or more of a capture date or the event occurrence and then initiating the next action.

### CROSS-REFERENCE TO RELATED APPLICATIONS

This application claims priority to and the benefit of U.S. Provisional Application No. 63/733,338, filed Dec. 12, 2024, titled “SYSTEMS AND METHODS TO ENHANCE VEGETATION CONTROL ALONG RIGHT-OF-WAYS”. This application also claims priority to and the benefit of U.S. Provisional Application No. 63/657,875, filed Jun. 9, 2024, titled “SYSTEMS AND METHODS TO ENHANCE VEGETATION CONTROL ALONG RIGHT-OF-WAYS,” the disclosures of which are incorporated herein by reference in their entireties.

### FIELD OF DISCLOSURE

The present disclosure relates to systems and methods to enhance vegetation control along a right-of-way.

### BACKGROUND

Pipeline is positioned throughout various environments worldwide to transport various fluids, such as hydrocarbons and/or renewable hydrocarbons, as well as water and/or other fluids, each in a liquid or gaseous state. For example, hundreds of thousands of miles of pipeline are positioned throughout the United States alone. A majority of such pipeline is buried or underground. Other buried or underground features are positioned worldwide as well, such as utility lines, sewage or septic lines or tanks, tunnels, and/or other various underground features.

Exposure of such pipeline, caused by erosion, weather events, unintentional interference (for example, digging along a right-of-way), and/or vegetation encroachment, may result in damage to or risk of damage to the pipeline or other underground features. A right-of-way has to remain clear of vegetation to ensure that such an exposure or a risk of exposure is detected and to ensure that the vegetation does not physically affect the underground feature. Typically, a person or technician may simply view the right-of-way, in-person, and, based on the knowledge of that person or technician, make a judgment as to whether the vegetation at the right-of-way should be managed (for example, cleared, cut, treated with a variety of herbicides, and/or removed). Further, as such judgement is based on a person's experience, such judgement could result in human error, for example, lack of recognition of protected plants or species or selection of a treatment not appropriate for the section of the right-of-way.

### SUMMARY

Thus, in view of the foregoing, Applicant has recognized these problems and others in the art, and has recognized a need for enhanced systems and methods to enhance vegetation control along a right-of-way.

The disclosure herein provides embodiments of systems and methods for vegetation control and assessment along a right-of-way quickly, utilizing less resources, and/or before the vegetation becomes a risk to a pipeline or another underground feature. Further, such systems and methods may ensure accurate and appropriate treatment for the vegetation at the right of way. Further still, such systems and methods may streamline typical right-of-way management, for example, initiating biological inspections, initiating capture of additional images, dispatching vehicles configured for vegetation treatment, contacting land owners, and/or storing a history associated with each right-of-way.

Such systems and methods may include a vegetation control system, apparatus, computing device, or controller. The vegetation control system may determine a plurality of right-of-way points on a geographical representation of a selected location (for example, the United States, or some other location that includes underground feature rights-of-way). Such a determination may be based on underground feature data, right-of-way location data, and/or georeferenced data. In such embodiments, the geographical representation may be displayed via a graphical user interface (GUI). The right-of-way points may be correlated to actual geographic locations represented via the geographical representation based on location data included in the data obtained. Thus, the vegetation control system may build a representation of a geographic location with a plurality of rights-of-way. In such embodiments, the geographical representation may be a map or an interactive map. In another embodiment, the right-of-way points may be represented by one or more different colored lines and/or dots or series of dots in a line. Each different color may represent a different status, for example, one status may indicate a right-of-way is up-to-date or current (for example, in relation to maintenance and/or vegetation growth), while another may indicate that a right-of-way may be untreated and/or may require treatment. Other indicators may indicate different statuses (for example, that a point includes protected vegetation and/or that a point may be treated with selected pesticide/herbicides, among other statuses).

Once a geographical representation has been populated with a plurality of right-of-way points, the vegetation control system may obtain data from a plurality of data sources in relation to the right-of-way points. The data sources may include one or more of a database (for example, storing data related to a plurality of rights-of-way), one or more vehicles (such as an aerial vehicle and/or other vehicles configured to capture images), one or more computing devices, and/or other data sources. The vegetation control system may obtain data related to the plurality of rights-of-way from one or more of the data sources. In embodiments, the data received from the data sources may include data packets, each part of the data packet specifying some type of data (for example, image data, location data, vegetation data, and/or other data).

Once the vegetation control system has obtained data, the vegetation control system may correlate the received data to the plurality of right-of-way points. Based on that correlation, the vegetation control system may store the data as metadata associated with each of the plurality of right-of-way points. Using the data, the vegetation control system may determine an event occurrence. An event occurrence may include an out-of-date visual inspection or a potential vegetation encroachment, among other events.

The vegetation control system may then determine a next action. The next action may be determined based on, for example, a capture date of the associated data (for example, such data indicating an out-of-date visual and/or biological inspection) and/or the event occurrence. If a next action is determined, then the vegetation control system may initiate that next action, such as initiating capture of additional images (such aerial or ground based images) initiating a biological survey, and/or initiating vegetation treatment.

In embodiments, each of the plurality of right-of-way points may be selectable. Upon selection, a second GUI, sub-GUI, or separate window may be generated. The sub-GUI may include the previously stored metadata.

Thus, vegetation control for a plurality of rights-of-way may be enhanced, enabling automated and/or user initiated actions based on collected data.

Accordingly, an embodiment of the disclosure is directed to a method to enhance vegetation control along an underground feature right-of-way. The method may include determining a plurality of right-of-way points on a graphical representation of a selected location based on underground feature data. The method may include obtaining a plurality of data packets from a plurality of sources, each of the plurality of data packets including one or more of underground feature characteristics or environment characteristics. The method may include correlating each of the plurality of data packets to a corresponding right-of-way point of the graphical representation. The method may include storing each of the plurality of data packets as metadata associated with the corresponding right-of-way. The method may include determining an event occurrence based on image data in each of the plurality of data packets. The method may include determining a next action for each of the plurality of right-of-way points based on one or more of a capture date or the event occurrence associated with a corresponding data packet. The method may include, in response to a determination of the next action, one or more of: (a) initiating capture of one or more aerial images or ground images of the right-of-way; (b) initiating a biological survey of a portion of the right-of-way; or (c) initiating vegetation treatment of the portion of the right-of-way.

In an embodiment, the initiation of the vegetation treatment includes: (a) determining one or more treatment plans at the portion of the right-of-way based on one or more of image data or biological analysis data in one or more of the plurality of data packets; (b) determining one or more types of vehicles to utilize at the portion of the right-of-way based on the one or more of the image data or the biological analysis data; and (c) dispatching a selected vehicle with a selected herbicide to the portion of the right-of-way. The one or more treatment plans may include one or more of vegetation removal, treatment with herbicide, or addition of a fill material. The determination of the one or more treatment plans is further based on one or more of vegetation type, vegetation height, or vegetation density at the right-of-way.

In another embodiment, the method may include displaying the plurality of right-of-way points on the graphical representation of the selected location and wherein the graphical representation comprises a graphical user interface (GUI). The method may further include, in response to selection of one of the plurality of right-of-way points, displaying metadata for the one of the plurality of right-of-way points in a sub-GUI. In embodiments, the sub-GUI may overlays the GUI.

In an embodiment, the underground feature characteristics may comprise one or more of underground feature type, underground feature depth, underground feature coordinates or location data, right-of-way coordinates or location data, or owner details. The environment characteristics may comprise one or more of vegetation type, vegetation height, vegetation depth, vegetation coverage, conservation status, local species, or other different environment features.

In another embodiment, the method may include, additionally, in response to the determination of the next action, initiating land-owner engagement.

Another embodiment of the disclosure is directed to a method to enhance vegetation control along a pipeline right-of-way. The method may include determining a plurality of right-of-way points on a graphical representation of a selected location based on one or more of pipeline right-of-way surveys, pipeline right-of-way images, geographical landmarks, or georeferencing data. The method may include obtaining a plurality of data packets from a plurality of sources, each of the plurality of data packets including one or more of pipeline characteristics or environment characteristics. The method may include correlating each of the plurality of data packets to a corresponding right-of-way point of the graphical representation. The method may include storing each of the plurality of data packets as metadata associated with the corresponding right-of-way. The method may include determining an event occurrence based on image data in each of the plurality of data packets. The method may include determining a next action for each of the plurality of right-of-way points based on one or more of a capture date or the event occurrence associated with a corresponding data packet. The method may include in response to a determination of the next action, one or more of: initiating capture of one or more aerial images or ground images of the pipeline right-of-way; initiating a biological survey of a portion of the pipeline right-of-way; or initiating vegetation treatment of the portion of the pipeline right-of-way.

In an embodiment, the method may include displaying an interactive image of one or more portions of the pipeline right-of-way and one or more of the plurality of right-of-way points via a GUI. Each of the plurality of right-of-way points may be displayed via the GUI comprise selectable points. The method may further include, in response to selection of one of the plurality of right-of-way points, displaying metadata associated with a selected right-of-way point.

In another embodiment, the method of may include displaying an interactive image of an entirety of the pipeline right-of-way and the plurality of right-of-way points via a GUI. The method may further include, in response to selection of a portion of the pipeline right-of-way, displaying a zoomed in view of a selected portion of the pipeline right-of-way and corresponding right-of-way points. The method may further include, in response to selection of one of the plurality of right-of-way points, displaying corresponding metadata.

Another embodiment of the disclosure is directed to a system to enhance vegetation control along an underground feature right-of-way. The system may include a communication circuitry. The a communication circuitry may be configured to receive data from one or more of an image capture aerial vehicle or one or more computing devices. The system may include a display circuitry. The display circuitry may be configured to generate, based on location data included in the data from one or more of an image capture aerial vehicle or one or more computing devices, a plurality of right-of-way representations on a geographical representation of a selected location, the geographical representation displayed via a graphical user interface (GUI). The system may include a vegetation control circuitry. The vegetation control circuitry may be configured to correlate the data from one or more of an image capture aerial vehicle or one or more computing devices to a corresponding right-of-way point of the graphical representation. The vegetation control circuitry may be configured to store the data from one or more of an image capture aerial vehicle or one or more computing devices as metadata associated with the corresponding right-of-way. The vegetation control circuitry may be configured to determine an event occurrence based on image data in the data from one or more of an image capture aerial vehicle or one or more computing devices. The vegetation control circuitry may be configured to determine a next action for each of the plurality of right-of-way points based on one or more of a capture date or the event occurrence associated with corresponding data. The vegetation control circuitry may be configured to, in response to a determination of the next action, one or more of: (a) initiate capture of one or more aerial images of the right-of-way, (b) initiate a biological survey of a portion of the right-of-way, or (c) initiate vegetation treatment of the portion of the right-of-way.

In an embodiment, the display circuitry may be configured to, in response to a selection of one of the plurality of right-of-way representations, display metadata associated with the one of the plurality of right-of-way representations in a sub-GUI overlayed against the GUI, wherein the sub-GUI includes a report button. The system may include a reporting circuitry. The reporting circuitry may be configured to, in response to selection of the report button, prompt selection of one or more types of reports. The reporting circuitry may be configured to, in response to selection of one or more types of reports, determine contents for one or more reports based on the metadata associated with the one of the plurality of right-of-way representations. The reporting circuitry may be configured to generate the one or more reports based on determined content. The types of reports may comprise one or more of a job safety analysis report, a herbicide record, a treatment data report, a status report, a notification tracking report, or a strategically managed vegetation or ranches (SGM) report.

In another embodiment, the underground feature may comprise a pipeline. One or more of a hydrocarbon fluid or a renewable fluid flows through the pipeline.

In another embodiment, the vegetation control circuitry may be further configured to, in response to initiation of capture of one or more images of the right-of-way: determine a corresponding portion of the right-of-way and dispatch a vehicle to capture the one or more images.

In yet another embodiment, the vegetation control circuitry may be further configured to, in response to initiation of vegetation management: determine one or more treatment plans at the portion of the right-of-way based on one or more of image data or biological analysis data in one or more of the plurality of data packets; determine one or more types of vehicles to utilize at the portion of the right-of-way based on the one or more of the image data or the biological analysis data; and dispatch a selected vehicle with a selected herbicide to the portion of the right-of-way.

In another embodiment, the vegetation control circuitry may be further configured to, in response to initiation of the biological survey: determine one or more entities to perform the biological survey and dispatch the one or more entities to the portion of the right-of-way. The one or more entities may include one or more of an autonomous vehicle or a biological specialist.

Another embodiment of the disclosure is directed to a computing device to enhance vegetation control along an underground feature right-of-way. The computing device may comprise one or more processors and a non-transitory computer-readable storage medium storing software instructions that, when executed by the one or more processors, in response to reception of data from one or more of an image capture aerial vehicle or one or more computing devices; generate, based on location data included in the data from the one or more of an image capture aerial vehicle or one or more computing devices, a plurality of right-of-way representations on a geographical representation of a selected location, the geographical representation displayed via a graphical user interface (GUI). The computing device may include instructions, when executed, correlate the data from one or more of an image capture aerial vehicle or one or more computing devices to a corresponding right-of-way point of the graphical representation. The computing device may include instructions, when executed, store the data from one or more of an image capture aerial vehicle or one or more computing devices as metadata associated with the corresponding right-of-way. The computing device may include instructions, when executed, determine an event occurrence based on image data in the data from one or more of an image capture aerial vehicle or one or more computing devices. The computing device may include instructions, when executed, in response to a determination of a next action for one of the plurality of right-of-way points based on one or more of a capture date or the event occurrence associated with corresponding data, one or more of: (a) initiate capture of one or more aerial images of the right-of-way, (b) initiate a biological survey of a portion of the right-of-way, or (c) initiate vegetation treatment of the portion of the right-of-way. In an embodiment, the event occurrence comprises one or more of vegetation encroachment along a right-of-way or over-grown vegetation along the right-of-way.

Still other aspects and advantages of these embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features herein disclosed, will become apparent through reference to the following description and the accompanying drawings. Furthermore, it is to be understood that the features of the various embodiments described herein are not mutually exclusive and may exist in various combinations and permutations.

### BRIEF DESCRIPTION OF DRAWINGS

These and other features, aspects, and advantages of the disclosure will become better understood with regard to the following descriptions, claims, and accompanying drawings. It is to be noted, however, that the drawings illustrate only several embodiments of the disclosure and, therefore, are not to be considered limiting of the disclosure's scope.

FIG. 1A, FIG. 1B, and FIG. 1C are simplified diagrams that illustrate systems for enhancing vegetation control along a right-of-way, according to an embodiment of the disclosure.

FIG. 2 is a simplified diagram that illustrates an apparatus for enhancing vegetation control along a right-of-way, according to an embodiment of the disclosure.

FIG. 3 is a simplified diagram that illustrates a control system for enhancing vegetation control along a right-of-way, according to an embodiment of the disclosure.

FIG. 4 is a simplified flow diagram for enhancing vegetation control along a right-of-way, according to an embodiment of the disclosure.

FIG. 5A, FIG. 5B, and FIG. 5C are examples of a graphical user interface for enhanced vegetation control, according to an embodiment of the disclosure.

### DETAILED DESCRIPTION

So that the manner in which the features and advantages of the embodiments of the systems and methods disclosed herein, as well as others, which will become apparent, may be understood in more detail, a more particular description of embodiments of systems and methods briefly summarized above may be had by reference to the following detailed description of embodiments thereof, in which one or more are further illustrated in the appended drawings, which form a part of this specification. However, it is to be noted that the drawings illustrate only various embodiments of the systems and methods disclosed herein and are therefore not to be considered limiting of the scope of the systems and methods disclosed herein as it may include other effective embodiments as well.

Typically, a technician may travel to a section or portion of a right-of-way to determine whether vegetation has encroached upon the right-of-way. The technician may rely solely upon their knowledge to make such a determination. Other current methods include simply sending a crew or group to the section of the right-of-way to manage the vegetation, regardless of whether vegetation management is required. Such actions are usually performed on a periodic basis or according to some pre-set, arbitrary schedule.

The disclosure herein provides embodiments of systems and methods for vegetation control and assessment along a right-of-way quickly, utilizing less resources, and/or before the vegetation becomes a risk to a pipeline or another underground feature. Further, such systems and methods may ensure accurate and appropriate treatment for the vegetation at the right of way at specific time periods, particularly in relation to potential vegetation and/or species located at a right-of-way that are protected. Further still, such systems and methods may streamline typical right-of-way management by initiating actions, for example, initiating biological inspections, initiating capture of additional images, dispatching vehicles configured for vegetation treatment, contacting land owners, and/or storing a history associated with each right-of-way. Such actions may be initiated at a time atypical to a pre-set or selected schedule. In other words, these actions may occur when there is a determination that they should occur, rather than on some pre-set, arbitrary schedule.

Such systems and methods may include a vegetation control system, apparatus, computing device, or controller. The vegetation control system may determine a plurality of right-of-way points on a geographical representation of a selected location (for example, the United States, North America, or some other location that includes underground feature rights-of-way). Such a determination may be based on underground feature data, right-of-way location data. In such embodiments, the geographical representation may be displayed via a graphical user interface (GUI). The right-of-way points may be correlated to actual geographic locations represented via the geographical representation based on location data included in the data obtained. Thus, the vegetation control system may build a representation of a geographic location with a plurality of rights-of-way. In such embodiments, the geographical representation may be a map. In another embodiment, the right-of-way points may be represented by one or more different colored lines and/or dots or series of dots in a line. Each different color may represent a different status, for example, one status may indicate a right-of-way is up-to-date or current, while another may indicate that a right-of-way may untreated. Other indicators may indicate different statuses (for example, that a point includes protected vegetation and/or that a point may be treated with selected pesticide/herbicides, among other statuses). As noted, the right-of-way may include an underground feature. The underground feature may include a pipeline, utility lines, sewage or septic lines or tanks, tunnels, and/or other various underground features.

In embodiments, as noted, the underground feature may include a pipeline. Such a pipeline may be used to transport fluids. Fluids may include water, waste water, hydrocarbons, and/or renewable fluids, among other types of fluids. “Hydrocarbons” or “hydrocarbon fluids” as used herein, may refer to petroleum fluids, hydrocarbon based renewable fluids, and other hydrocarbon based fluids. “Petroleum fluids” as used herein, may refer to fluid products containing crude oil, petroleum products, natural gas, renewable liquids and/or gasses, and/or distillates or refinery intermediates. For example, crude oil contains a combination of hydrocarbons having different boiling points that exists as a viscous liquid in underground geological formations and at the surface. Petroleum products, for example, may be produced by processing crude oil and other liquids at petroleum refineries, by extracting liquid hydrocarbons at natural gas processing plants, and by producing finished petroleum products at industrial facilities. For example, a petroleum product may include a transportation fuel, among other products. Refinery intermediates, for example, may refer to any refinery hydrocarbon that is not crude oil or a finished petroleum product (such as gasoline), including all refinery output from distillation (for example, distillates or distillation fractions) or from other conversion units. In some non-limiting embodiments of systems and methods, petroleum fluids may include heavy blend crude oil used at a pipeline origination station, natural gas, and/or other types of crude oil, as will be understood by one skilled in the art. “Renewable fluids” as used herein, may refer to fluid products containing plant and/or animal derived feedstock. Further, the renewable fluids may be hydrocarbon based. For example, a renewable fluid may be a pyrolysis oil, oleaginous feedstock, biomass derived feedstock, natural gas or other liquids or gasses, as will be understood by those skilled in the art.

Once a geographical representation has been populated with a plurality of right-of-way points, the vegetation control system may obtain data from a plurality of data sources. The data sources may include one or more of a database (for example, storing data related to a plurality of rights-of-way), one or more vehicles (such as an aerial vehicle, a land-based vehicle, unmanned vehicles, and/or autonomous vehicles, among other vehicles configured to capture images), one or more computing devices, and/or other data sources. The vegetation control system may obtain data related to the plurality of rights-of-way from one or more of the data sources. In embodiments, the data received from the data sources may include data packets, each part of the data packet specifying some type of data (for example, image data, location data, vegetation data, and/or other data). For example, a header may be positioned prior to a specific type of data to indicate that the next bits include that type of data.

Once the vegetation control system has obtained data, the vegetation control system may correlate the received data to the plurality of right-of-way points. Based on that correlation, the vegetation control system may store the data as metadata associated with each of the plurality of right-of-way points. Using the data, the vegetation control system may determine an event occurrence. An event occurrence may include an out-of-date visual inspection or a potential vegetation encroachment, among other events.

The vegetation control system may then determine a next action. The next action may be determined based on, for example, a capture date of the associated data (for example, such data indicating an out-of-date visual and/or biological inspection) and/or the event occurrence. If a next action is determined, then the vegetation control system may initiate that next action, such as initiating capture of additional images (such aerial or ground based images) initiating a biological survey, and/or initiating vegetation treatment.

In embodiments, each of the plurality of right-of-way points may be selectable (for example via a selectable or interactive interface or GUI). Upon selection, a second GUI, sub-GUI, or separate window may be generated. The sub-GUI may include the previously stored metadata.

Thus, vegetation control for a plurality of rights-of-way may be enhanced, enabling automated and/or user initiated actions based on collected data, rather than basing actions on arbitrary, preset schedules. Further, such actions may occur quicker than typical. In other words, rather than waiting unit a scheduled time to perform some action, the vegetation control system may determine appropriate times to actually perform such an action.

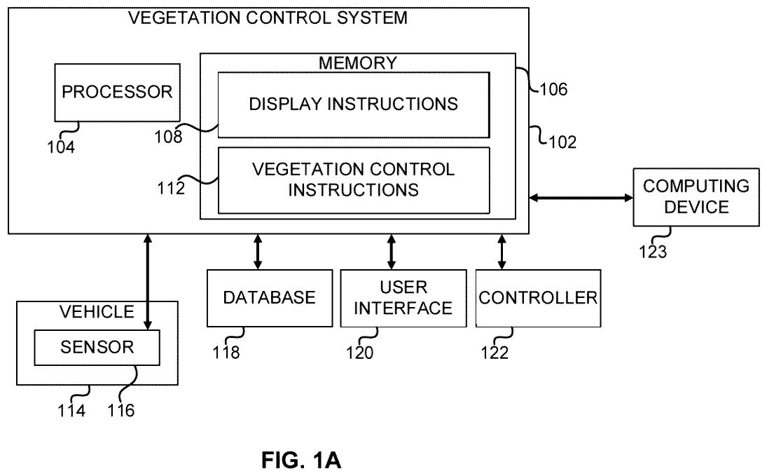

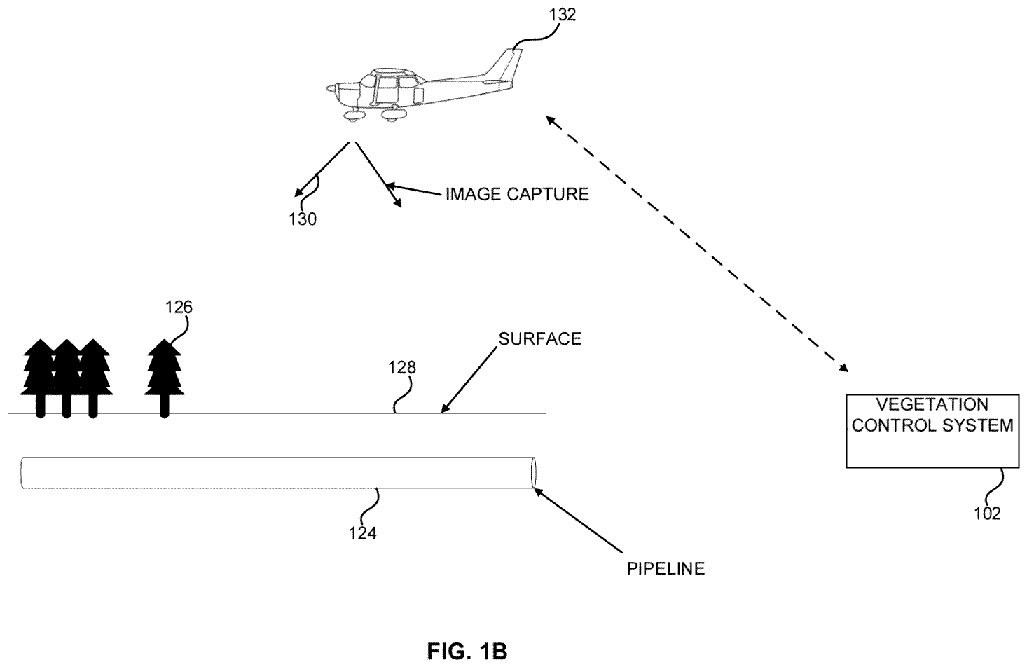

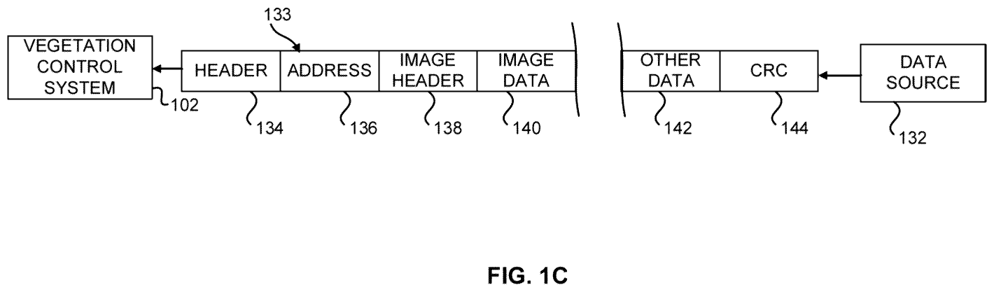

FIG. 1A, FIG. 1B, and FIG. 1C are simplified diagrams that illustrate systems for enhancing vegetation control along a right-of-way, according to an embodiment of the disclosure. As illustrated the vegetation control system 102 may connect to one or more data sources. The one or more data sources may include a vehicle 114 (for example, including a sensor 116), a database 118, a user interface 120, a controller 122, and/or a computing device 123. For example, vegetation control system 102 may obtain data, in real-time and/or periodically, from a vehicle 114 capturing images and/or other data via a sensor 116 or via a plurality of sensors. In a further example, the vehicle 114 may include a manned vehicle, an unmanned or autonomous vehicle, an airplane, a drone, a utility vehicle, an all-terrain vehicle, and/or other vehicle capable of traversing a right-of-way at the ground level or via the airspace above the right-of-way.

For example, as illustrated in FIG. 1B, the right-of-way 128 may include a pipeline 124 below the surface of the of the right-of-way 128. In such an example, the vegetation control system 102 may prompt and/or receive data packets or data from an airplane 132 traversing the airspace of the right-of-way 128. The airplane 132 may capture images (see 130) of the right-of-way 128, such images including vegetation, such as trees 126, grass, shrubs, bushes, other types of plants, and/or other types of inorganic structures or features. The captured images, along with other data, such as location data, a timestamp, and/or a data source identifier or indicator, may then be transferred to the vegetation control system 102, for example as a data stream and/or data packet. As noted, the vegetation control system 102 may connect to other data sources, such as a database 118 and/or other devices.

The vegetation control system 102 may include a processor 104 and a memory 106. The memory 106 may store instructions executable by the processor 104. In some examples, the vegetation control system 102 may be a computing device. The term “computing device” is used herein to refer to any one or all of programmable logic controllers (PLCs), programmable automation controllers (PACs), industrial computers, servers, virtual computing device or environment, desktop computers, personal data assistants (PDAs), laptop computers, tablet computers, smart books, palm-top computers, personal computers, smartphones, virtual computing devices, cloud based computing devices, and similar electronic devices equipped with at least a processor and any other physical components necessarily to perform the various operations described herein. Devices such as smartphones, laptop computers, and tablet computers are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

As used herein, a “non-transitory machine-readable storage medium,” “non-transitory computer-readable storage medium,” or “memory” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. The memory may store or include instructions executable by the processor.

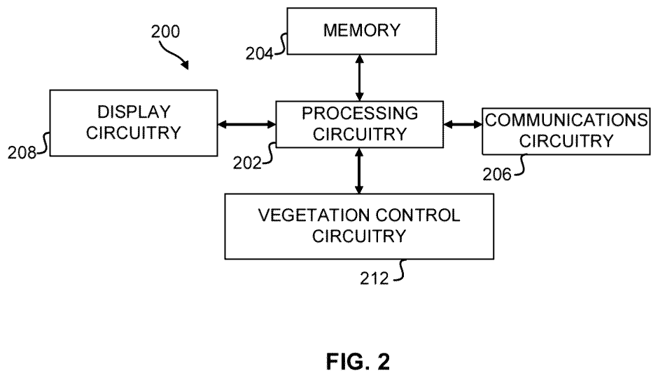

As used herein, a “processor” or “processing circuitry” may include, for example one processor or multiple processors included in a single device or distributed across multiple computing devices. The processor (such as, processor 104 shown in FIG. 1A or processing circuitry 202 shown in FIG. 2) may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

As noted, the memory 106 of the vegetation control system 102 may store instructions. The instructions may include display instructions 108 and vegetation control instructions 112. The display instructions 108 when executed by the processor 104, may generate a graphical user interface (GUI) for the user interface 120. To generate the GUI, the display instructions 108 may, when executed by the processor 104, determine a plurality of right-of-way points on a geographical representation of a selected location. In embodiments, the location may be pre-selected or pre-determined based on the operating area managed by the vegetation control system 102. In another embodiment, the selected location may be specified by a user via the user interface 120. In yet another embodiment, the selected location may be determined based on data available. For example, if the data available to the vegetation control system 102 includes data for North America, then the vegetation control system 102 may determine that the selected location is North America. Further, the vegetation control system 102 may utilize geographic information system (GIS) data for determination of the selected location.

Once a selected location is determined, as noted, the vegetation control system 102 may determine the plurality of right-of-way points for the selected location. In such embodiments, the vegetation control system 102 may determine such right-of-way points based on data. Such data may be historical data (for example, database 118 may store historical data related to a plurality of rights-of-way) and/or current captured data (for example, the vehicle 114 may capture data related to one or more rights-of-way). Such data may include location data (for example, from a global positioned system (GPS) or GIS). Further, the data may include other details related to the right-of-way, including, but not limited to, type of underground feature at a right-of-way, land ownership information, length and/or width of the right-of-way, vegetation data, images, a timestamp and/or time of data capture, and/or other data related to the right-of-way. Using such data, the vegetation control system 102 may correlate the right-of-way data with data for the selected location, creating a series of points on the geographical representation.

Once the plurality of right-of-way points are determined, the vegetation control system 102 may display each point on the geographical representation via the GUI of the user interface 120. In an embodiment, the vegetation control system 102 may include a zoom in/zoom out feature that enables the user interface 120 to zoom into various locations of the geographical representation. Further, the vegetation control system 102 may cause each of the rights-of-way points to be selectable via the GUI of the user interface 120. Further, the additional data for each right-of-way point may be stored as metadata associated with a selected right-of-way point. Further, the vegetation control system 102 may enable each right-of-way point, when selected, to cause a sub-GUI or separate window to appear. The sub-GUI or separate window may display the data associated with that right-of-way point.

Once the geographical representation with the plurality of right-of-way points is determined and/or generated, then the vegetation control system 102 may execute the vegetation control instructions 112. The vegetation control instructions 112, when executed may cause capture of new data related to one or more of the right-of-way points. In another embodiment, the vegetation control system 102 may execute the vegetation control instructions 112 when data is received. Such data may include images, biological assessments, ownership information, and/or other right-of-way information (for example, type of underground feature at a right-of-way, land ownership information, length and/or width of the right-of-way, vegetation data, images, a timestamp and/or time of data capture, and/or other data related to the right-of-way). In an embodiment, the vegetation control system 102 may execute the vegetation control instructions 112 for different portions of one or more rights-of-way based on the data received for each portion. For example, the vegetation control system 102 may initiate or execute the vegetation control instructions 112 for varying lengths of a right-of-way at one or more selected times (for example, portions of a right-of-way may be based on the total length of the right-of-way).

Once the new data has been received for one or more of the rights-of-way, the vegetation control instructions 112 may correlate the data to an existing right-of-way point.

In another embodiment, the vegetation control instructions 112 may be executed periodically, at selected time intervals, and/or after an event (for example, data has been captured, a user has prompted execution, and/or a change has occurred at the right-of-way).

In another embodiment, execution of the vegetation control instructions 112 may cause the vegetation control system 102 to determine whether an event has occurred. For example, the vegetation control system 102 may determine whether vegetation has exceed some threshold at the right-of-way, whether a biological analysis has lapsed, and/or whether another change has occurred. For example, the vegetation control system 102 may determine an event has occurred based on the width of a right-of-way and potential and/or predicted encroachment on that width of the right-of-way. In another embodiment, the vegetation control system 102 may determine a width of the right-of-way based on the type of right-of-way and/or the depth of the underground feature associated with the right-of-way. After the determination that an event has occurred, the vegetation control system 102 may then determine a next action based on the event and/or date that data has been captured. For example, if images for right-of-way have been captured at some previous selected time period or interval, then the vegetation control system 102 may determine that a next action is to capture additional images at the right-of-way (for example, via an aerial or land-based vehicle). In another example, the vegetation control system 102 may determine that a next action is a biological survey. Such a determination may be based on a previously performed biological survey, whether proximate right-of-way points have undergone biological surveys and have included potential points of conservation, and/or whether visual inspection and/or images indicate presence of protected vegetation and/or species. If a determination is made in relation to a biological survey, then the vegetation control system 102 may cause or initiate such a survey. Such an initiation may include causing an autonomous vehicle to traverse the right-of-way and/or prompting a specialist or biological specialist to traverse the right-of-way. The results of the biological survey, once completed, may be transmitted to the vegetation control system 102 and stored as metadata for one or more right-of-way points.

In another example, the vegetation control system 102 may determine and/or initiate a vegetation treatment for one or more right-of-way points. The vegetation control system 102 may first determine a vegetation treatment plan. Determination of such a plan may include determining a type, amount, density, and/or height of vegetation at a right-of-way point. Based on those determinations, the vegetation control system 102 may determine a type of treatment to use. Type of treatment may include use of herbicide, use of pesticide, vegetation removal, vegetation trimming, removal of material at the right-of-way points, and/or addition of fill material. Further, based on potential conservation status of a right-of-way, the treatment may include an environmentally-friendly alternative, such as conservation mowing, enhanced planting, grazing, tree reclamation, and/or hand-clearing of Once a treatment plan is determined, the vegetation control system 102 may initiate the vegetation treatment plan. Initiation of the vegetation treatment plan may include causing or prompting a vehicle configured to apply a herbicide and/or pesticide to proceed to a selected location and/or causing or prompting a vehicle or personnel to remove, cut-back, or trim vegetation at a selected location.

Once the treatment has been executed, the vegetation control system 102 may store data and/or records associated with the treatment as metadata associated with one or more of the right-of-way points. Further, the vegetation control system 102 may generate and/or include an option to generate a report. The report may indicate actions performed, conservation status, regulatory compliance, and/or other details.

In an embodiment, the vegetation control system 102 may initiate verification of vegetation treatment. For example, after treatment occurs (or for example, after the vegetation control system 102 receives data indicative of treatment), the vegetation control system 102 may initiate additional image captures of a right-of-way or a portion or portions of the right-of-way. The vegetation control system 102 may then verify that treatment has occurred and that the treatment was effective. The vegetation control system 102 may determine effectiveness based on differences between images and/or data captured before and after treatment. In another embodiment, the vegetation control system 102 may initiate verification and/or follow-up at different time periods after treatment (for example, immediately after, one day after, a week after, a month after, or longer).

As noted, the vegetation control system 102 may receive data packets 133 from one or more data sources (for example, a data source including an airplane 132, drone, or other vehicle or device including equipment configured to capture images and/or other data of a right-of-way). The data packet 133 may include various portions indicating a type of data followed by the data. For example, the data packet may include a header 134 indicating an incoming address 136. The address 136 may indicate the device to receive the data (for example, in this case, the vegetation control system 102. Other data may precede such a header 134 and/or address 136 that indicate, for example, the source of the data packet. The data packet 133 may include an image header 138 followed by image data 140. Further, other data 142 may be included in the data packet 133. Finally, the data packet 133 may include cyclic redundancy check (CRC) bits 144 to ensure that the data is accurate.

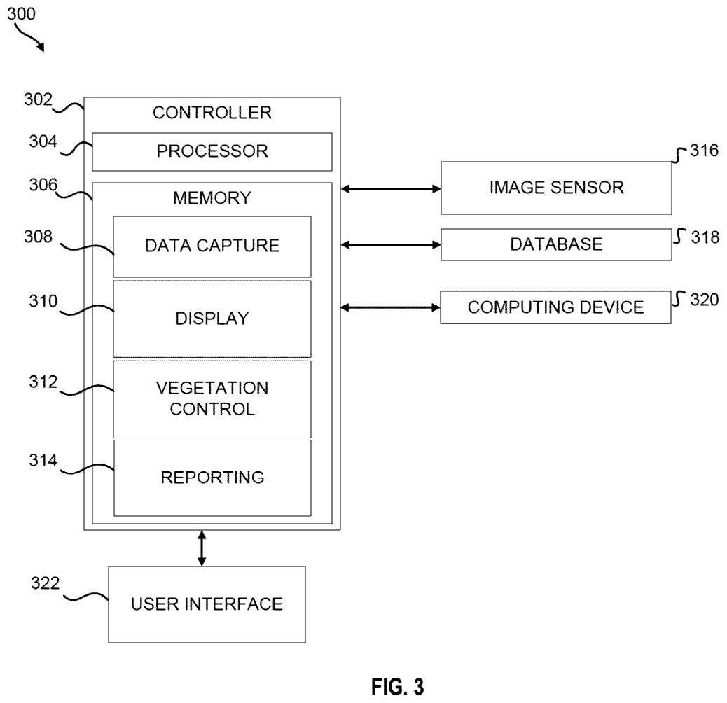

FIG. 2 is a simplified diagram that illustrates an apparatus for enhancing vegetation control along a right-of-way, according to an embodiment of the disclosure. Such an apparatus 200 may be comprised of a processing circuitry 202, a memory 204, a communications circuitry 206, a display circuitry 208, and a vegetation control circuitry 212, each of which will be described in greater detail below. While the various components are illustrated in FIG. 2 as being connected with processing circuitry 202, it will be understood that the apparatus 200 may further comprise a bus (not expressly shown in FIG. 2) for passing information amongst any combination of the various components of the apparatus 200. The apparatus 200 may be configured to execute various operations described herein, such as those described above in connection with FIGS. 1A-1C and below in connection with FIGS. 3-5C.

The processing circuitry 202 (and/or co-processor or any other processor assisting or otherwise associated with the processor) may be in communication with the memory 204 via a bus for passing information amongst components of the apparatus. The processing circuitry 202 may be embodied in a number of different ways and may, for example, include one or more processing devices configured to perform independently. Furthermore, the processor may include one or more processors configured in tandem via a bus to enable independent execution of software instructions, pipelining, and/or multithreading.

The processing circuitry 202 may be configured to execute software instructions stored in the memory 204 or otherwise accessible to the processing circuitry 202 (for example, software instructions stored on a separate storage device). In some cases, the processing circuitry 202 may be configured to execute hard-coded functionality. As such, whether configured by hardware or software methods, or by a combination of hardware with software, the processing circuitry 202 represents an entity (for example, physically embodied in circuitry) capable of performing operations according to various embodiments of the present disclosure while configured accordingly. Alternatively, as another example, when the processing circuitry 202 is embodied as an executor of software instructions, the software instructions may specifically configure the processing circuitry 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus 200 to carry out various functions in accordance with example embodiments contemplated herein.

The communications circuitry 206 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network. Furthermore, the communications circuitry 206 may include the processing circuitry for causing transmission of such signals to a network or for handling receipt of signals received from a network. The communications circuitry 206, in an embodiment, may enable reception of images captured by a vehicle and/or other data related to rights—of way.

The apparatus 200 may include display circuitry 208 configured to determine a plurality of right-of-way points or representations for a geographical representation of a selected location for display via a GUI. Such a determination may be based on location data form one or more data sources. Further, if such a determination cannot be made without additional data, then the display circuitry 208 may initiate capture of additional data, for example via a database and/or vehicle configured to capture such images. Such a geographical representation, including the right-of-way points or representations, may be displayed via a GUI of a user interface. In another embodiment, the geographical representation may be displayed via a web-based user interface and/or an application (for example, a mobile application for a smart phone or other smart device). The display circuitry 208 may utilize processing circuitry 202, memory 204, or any other hardware component included in the apparatus 200 to perform these operations. The display circuitry 208 may further utilize communications circuitry 206, as noted above, to gather data (such as images and/or right-of-way information) from a variety of sources (for example, from a database, the memory 204, via a user interface, from a vehicle, and/or from another source). The output of the display circuitry 208 may be transmitted to other circuitry of the apparatus 200 (such as a user interface and/or the vegetation control circuitry 212).

The apparatus 200 further comprises the vegetation control circuitry 212 that may receive images and/or data of a right-of-way, correlate the data to a corresponding right-of-way point, store the data as metadata associated with the corresponding right-of-way point, determine an event occurrence, determine a next action based on event occurrence, and/or initiate the next action. The vegetation control circuitry 212 may utilize processing circuitry 202, memory 204, or any other hardware component included in the apparatus 200 to perform these operations. The vegetation control circuitry 212 may further utilize communications circuitry 206 to transmit an alert to a user, controller, and/or computing device.

Although components 202-212 are described in part using functional language, it will be understood that the particular implementations necessarily include the use of particular hardware. It should also be understood that certain of these components 202-212 may include similar or common hardware. For example, the display circuitry 208, and the vegetation control circuitry 212 may, in some embodiments, each at times utilize the processing circuitry 202, memory 204, or communications circuitry 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” with respect to elements of the apparatus therefore shall be interpreted as necessarily including the particular hardware configured to perform the functions associated with the particular element being described. Of course, while the terms “circuitry” should be understood broadly to include hardware, in some embodiments, the terms “circuitry” may in addition refer to software instructions that configure the hardware components of the apparatus 200 to perform the various functions described herein.

Although the display circuitry 208, and the vegetation control circuitry 212 may leverage processing circuitry 202, memory 204, or communications circuitry 206 as described above, it will be understood that any of these elements of apparatus 200 may include one or more dedicated processors, specially configured field programmable gate arrays (FPGA), or application specific interface circuits (ASIC) to perform its corresponding functions, and may accordingly leverage processing circuitry 202 executing software stored in a memory or memory 204, communications circuitry 206 for enabling any functions not performed by special-purpose hardware elements. In all embodiments, however, it will be understood that the survey and display circuitry 208 and the vegetation control circuitry 212 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200 (or by a controller 302). Furthermore, some example embodiments (such as the embodiments described for FIGS. 1A and 3) may take the form of a computer program product comprising software instructions stored on at least one non-transitory computer-readable storage medium (such as memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces or provides a special-purpose machine comprising the means for implementing various functions described herein.

FIG. 3 is a simplified diagram that illustrates a control system for enhancing vegetation control along a right-of-way, according to an embodiment of the disclosure. The controller 302 may connect to one or more various components or devices. Such components or devices may include a vehicle (for example, an image sensor 316), a database 318, and/or a computing device 320. The controller 302 may obtain data from the one or more components or devices. The controller 302 may poll and/or request the data from the one or more component or devices. Further, the controller 302 may prompt the components or devices to perform an action. As used herein, “signal communication” refers to electric communication such as hardwiring two components together or wireless communication, as understood by those skilled in the art. For example, wireless communication may be Wi-Fi®, Bluetooth®, ZigBee, or forms of near-field communications. In addition, signal communication may include one or more intermediate controllers or relays disposed between elements in signal communication.

The controller 302 may include instructions. The instructions may include data capture instructions 308. When executed, the controller 302 may initiate or request data from a corresponding source. The controller 302 may include display instructions 310. The display instructions 310 may cause the controller 302 to generate a GUI for the user interface 322. The GUI may include a geographical representation of a selected location. Further, the controller 302 may insert or overlay selectable points corresponding to a plurality of rights-of-way. Such insertion or overlay may be based on data received from the one or more components or devices.

The controller 302 may include vegetation control instructions 312. The vegetation control instructions 312 may cause the controller 302 to determine whether an event has occurred. An event occurrence may include vegetation encroachment of a right-of-way, biological assessment or survey lapse, and/or lack of image data. In response to an event occurrence, the controller 302 may determine a next action. The next action may include capturing additional images (based on execution of the data capture instructions 308) of a right-of-way, prompting a biological survey, automatically capturing additional images for a biological survey, determining a treatment plan, and/or executing a treatment plan.

The controller 302 may additionally include reporting instructions 314. The reporting instructions 314may include generating reports based on local and/or federal rules and/or regulations regarding conservation and/or right-of-way operation. In another embodiment, the controller 302 may include instructions to automatically generate letters and/or communications to land owners.

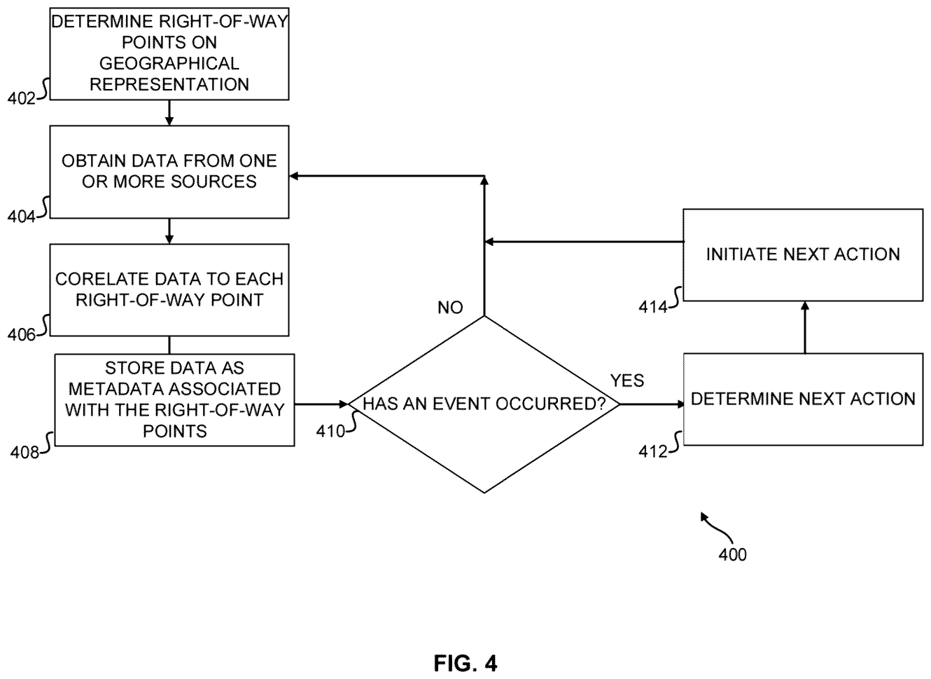

FIG. 4 is a simplified flow diagram for enhancing vegetation control along a right-of-way, according to an embodiment of the disclosure. Unless otherwise specified, the actions of method 400 may be completed within controller 302. Specifically, method 400 may be included in one or more programs, protocols, or instructions loaded into the memory of controller 302 and executed on the processor or one or more processors of the controller 302. In other embodiments, method 400 may be implemented in or included in components of FIGS. 1A-3. The order in which the operations are described is not intended to be construed as a limitation, and any number of the described blocks may be combined in any order and/or in parallel to implement the methods.

At block 402, the controller 302 may determine right-of-way points on a geographical representation at a selected location. Each of the right-of-way points may store a set of metadata associated with the actual, physical location of the right-of-way, such as location data, status, images, and/or other characteristics or aspects of the right-of-way. The right-of-way points and geographical representation may be displayed via a GUI. The right-of-way points may be selectable and, when selected, may open an sub-GUI or separate window including the metadata.

At block 404, the controller 302 may obtain data from one or more sources. The data may include updated images of one or more of the right-of-way points. At block 406, the controller 302 may correlate the captured data to a corresponding right of way. At block 408, the controller 302 may store the data as metadata associated with the corresponding right-of-way. At block 410, the controller 302 may determine whether an event has occurred. If an event has occurred, then the controller 302, at block 412, may determine a next action. At block 414, the controller 302 may execute or initiate the next action.

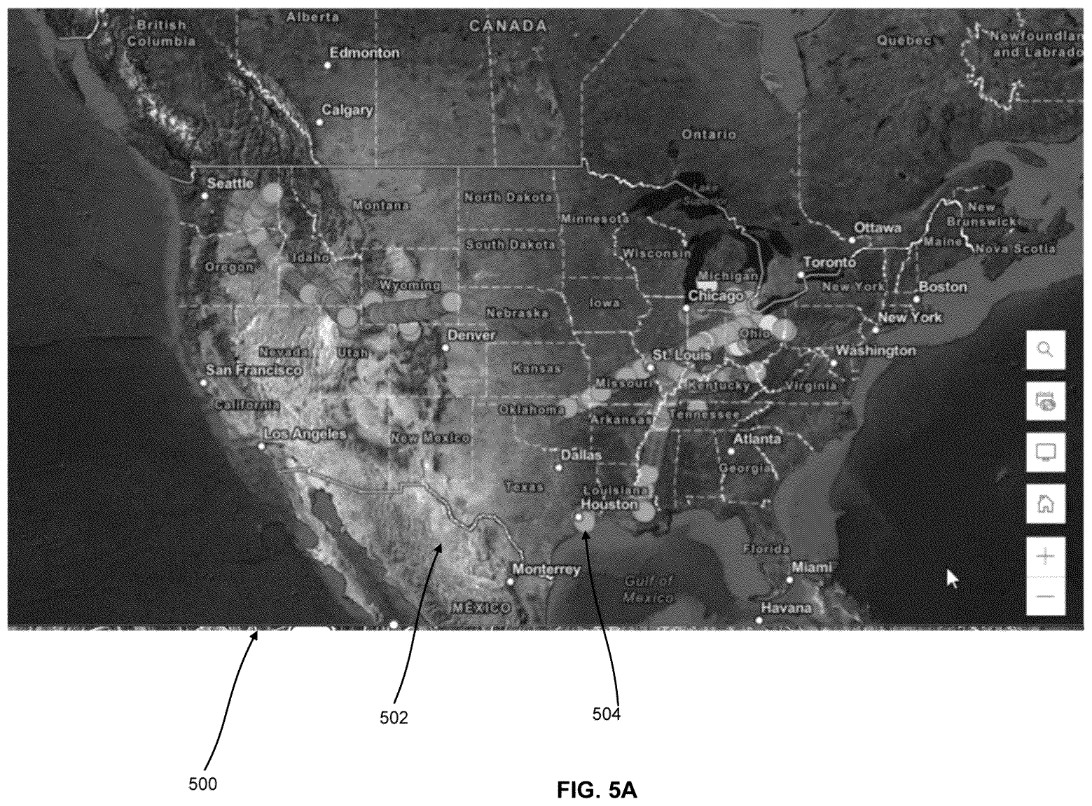

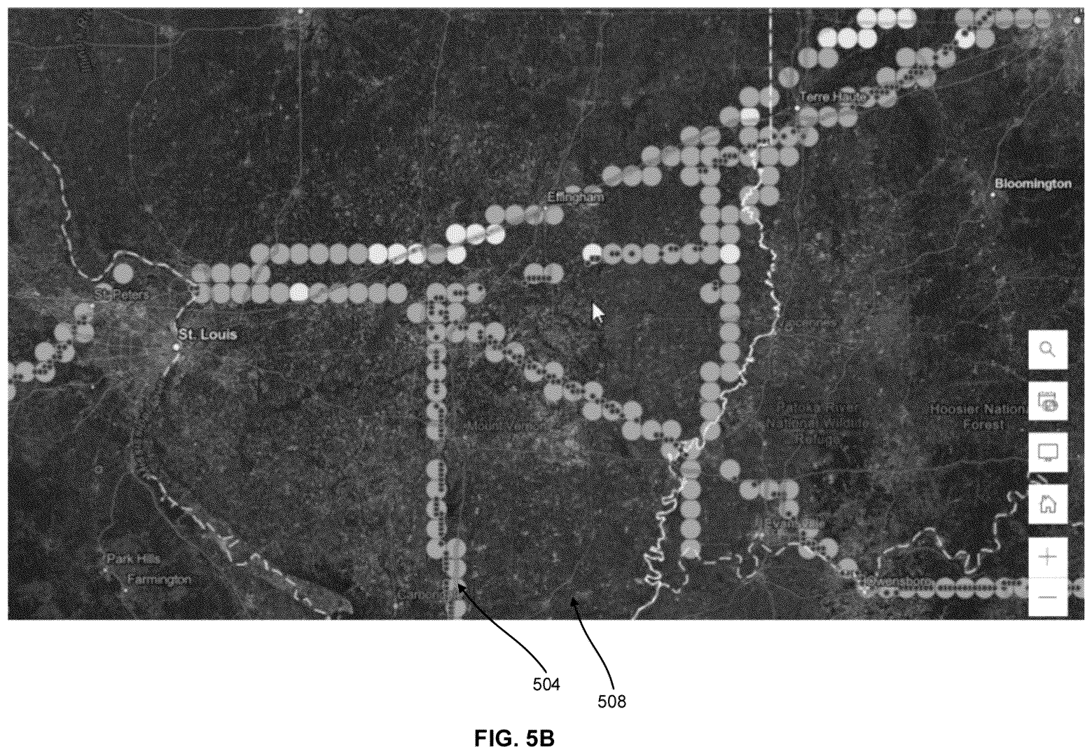

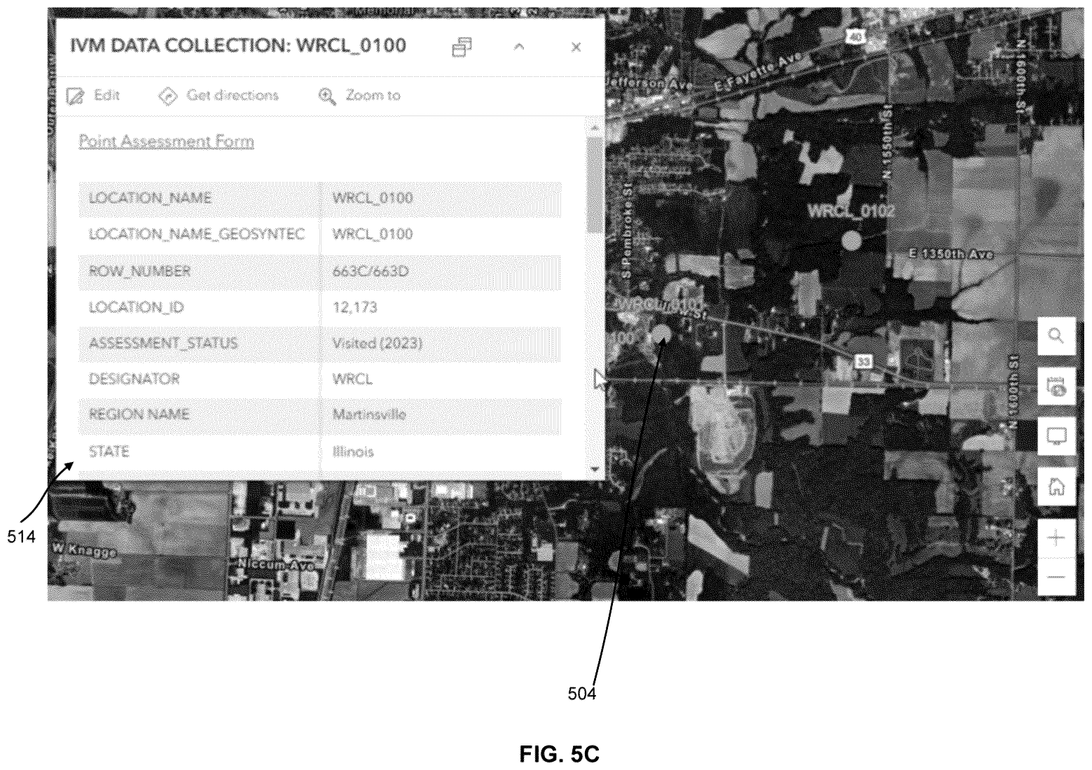

FIG. 5A, FIG. 5B, and FIG. 5C are examples of a graphical user interface for enhanced vegetation control, according to an embodiment of the disclosure. Turning first to FIG. 5A, a vegetation control system may generate, for a GUI, a geographical representation 502 of a selected location. As illustrated, the geographical representation 502 comprises a topographical view. In other embodiments, the geographical representation 502 may include a flat view, without topographical features illustrated. As noted, the plurality of right-of-way points 504 may include a series of dots, each representing a point or location of a physical right-of-way.

In FIG. 5B, a user may select a particular portion of the geographical representation 502 to zoom in or expand that particular portion, thus producing a focused geographical representation 508. In FIG. 5C, when a user selects a particular right-of-way point 504, a sub-GUI, separate window, or pop-up including data corresponding to the right-of-way.

This application is related to U.S. Provisional Application No. 63/657,875, filed Jun. 9, 2024, titled “SYSTEMS AND METHODS TO ENHANCE VEGETATION CONTROL ALONG RIGHT-OF-WAYS,” the disclosure of which is incorporated herein by reference in its entirety.

Although specific terms are employed herein, the terms are used in a descriptive sense only and not for purposes of limitation. Embodiments of systems and methods have been described in considerable detail with specific reference to the illustrated embodiments. However, it will be apparent that various modifications and changes can be made within the spirit and scope of the embodiments of systems and methods as described in the foregoing specification, and such modifications and changes are to be considered equivalents and part of this disclosure.

1. A method to enhance vegetation control along an underground feature right-of-way, the method comprising:
determining a plurality of right-of-way points on a graphical representation of a selected location based on one or more of underground feature data, pipeline right-of-way surveys, pipeline right-of-way images, geographical landmarks, or georeferencing data;
obtaining a plurality of data packets from a plurality of sources, each of the plurality of data packets including one or more of underground feature characteristics, pipeline characteristics, or environment characteristics;
correlating each of the plurality of data packets to a corresponding right-of-way point of the graphical representation;
storing each of the plurality of data packets as metadata associated with the corresponding right-of-way;
determining an event occurrence based on image data in each of the plurality of data packets;
determining a next action for each of the plurality of right-of-way points based on one or more of a capture date or the event occurrence associated with a corresponding data packet; and
in response to a determination of the next action, one or more of:
initiating capture of one or more aerial images or ground images of the right-of-way,
initiating capture of one or more aerial images or ground images of the pipeline right-of-way,
initiating a biological survey of a portion of the right-of-way, or
initiating vegetation treatment of the portion of the right-of-way.

2. The method of claim 1, wherein initiation of the vegetation treatment includes:
determining one or more treatment plans at the portion of the right-of-way based on one or more of image data or biological analysis data in one or more of the plurality of data packets;
determining one or more types of vehicles to utilize at the portion of the right-of-way based on the one or more of the image data or the biological analysis data; and
dispatching a selected vehicle with a selected herbicide to the portion of the right-of-way.

3. The method of claim 2, wherein the one or more treatment plans includes one or more of vegetation removal, treatment with herbicide, or addition of a fill material based on one or more of vegetation type, vegetation height, or vegetation density.

4. The method of claim 3, wherein addition of the fill material comprises selecting a fill type from topsoil, aggregate or engineered ballast based on soil-stability data.

5. The method of claim 2, wherein determining the selected herbicide comprises selecting an active ingredient and dosage responsive to a detected vegetation density and species.

6-7. (canceled)

8. The method of claim 1, further comprising displaying the plurality of right-of-way points on the graphical representation of the selected location and wherein the graphical representation comprises a graphical user interface (GUI).

9. The method of claim 8, wherein the GUI renders each right-of-way point in a color that denotes a status selected from: (i) up-to-date, (ii) treatment due, (iii) protected vegetation present.

10-12. (canceled)

13. The method of claim 8, further comprising in response to selection of one of the plurality of right-of-way points, displaying metadata for the one of the plurality of right-of-way points in a sub-GUI.

14. (canceled)

15. The method of claim 1, wherein the underground feature characteristics comprise one or more of underground feature type, underground feature depth, underground feature coordinates or location data, right-of-way coordinates or location data, or owner details, wherein the environment characteristics comprise one or more of vegetation type, vegetation height, vegetation depth, vegetation coverage, conservation status, local species, or other different environment features, and wherein the underground feature type comprises a pipeline, utility lines, sewage or septic lines or tanks, or tunnels.

16. The method of claim 1, further comprising, additionally in response to the determination of the next action, initiating land-owner engagement including automatically generating a notification letter referencing pertinent local vegetation-management regulation.

17. (canceled)

18. The method of claim 1, wherein the plurality of sources further comprises a satellite platform providing multispectral imagery of the right-of-way.

19. The method of claim 1, wherein obtaining the plurality of data packets comprises acquiring LiDAR point-cloud data from a ground vehicle traversing the right-of-way.

20-21. (canceled)

22. The method of claim 1, wherein determining the event occurrence comprises (i) computing a permissible vegetation buffer width from an underground-feature depth and (ii) flagging vegetation that penetrates the buffer.

23-31. (canceled)

32. A system to enhance vegetation control along an underground feature right-of-way, the system comprising:
a communication circuitry configured to:
receive data from one or more of an image capture aerial vehicle or one or more computing devices;
a display circuitry configured to:
generate, based on location data included in the data from one or more of an image capture aerial vehicle or one or more computing devices, a plurality of right-of-way representations on a geographical representation of a selected location, the geographical representation displayed via a graphical user interface (GUI); and
a vegetation control circuitry configured to:
correlate the data from one or more of an image capture aerial vehicle or one or more computing devices to a corresponding right-of-way point of the graphical representation,
store the data from one or more of an image capture aerial vehicle or one or more computing devices as metadata associated with the corresponding right-of-way,
determine an event occurrence based on image data in the data from the one or more of the image capture aerial vehicle or the one or more computing devices,
determine a next action for each of the plurality of right-of-way points based on one or more of a capture date or the event occurrence associated with corresponding data, and
in response to a determination of the next action, one or more of:
initiate capture of one or more images of the right-of-way,
initiate a biological survey of a portion of the right-of-way, or
initiate vegetation treatment of the portion of the right-of-way.

33. The system of claim 32, wherein the display circuitry is further configured to, in response to a selection of one of the plurality of right-of-way representations, display metadata associated with the one of the plurality of right-of-way representations in a sub-GUI overlayed against the GUI, wherein the sub-GUI includes a report button.

34. The system of claim 33, further comprising a reporting circuitry configured to:
in response to selection of the report button, prompt selection of one or more types of reports;
in response to selection of one or more types of reports, determine contents for one or more reports based on the metadata associated with the one of the plurality of right-of-way representations; and
generate the one or more reports based on determined content.

35. (canceled)

36. The system of claim 32, wherein the underground feature comprises a pipeline.

37-41. (canceled)

42. The system of claim 32, wherein the vegetation control circuitry is further configured to, in response to initiation of the biological survey:
determine one or more entities to perform the biological survey; and
dispatch the one or more entities to the portion of the right-of-way.

43. The system of claim 42, wherein the one or more entities comprise one or more of an autonomous vehicle or a biological specialist.

44. A computing device to enhance vegetation control along an underground feature right-of-way, the computing device comprising one or more processors and a non-transitory computer-readable storage medium storing software instructions that, when executed by the one or more processors:
in response to reception of data from one or more of an image capture aerial vehicle or one or more computing devices; generate, based on location data included in the data from the one or more of an image capture aerial vehicle or one or more computing devices, a plurality of right-of-way representations on a geographical representation of a selected location, the geographical representation displayed via a graphical user interface (GUI);
correlate the data from one or more of an image capture aerial vehicle or one or more computing devices to a corresponding right-of-way point of the graphical representation;
store the data from one or more of an image capture aerial vehicle or one or more computing devices as metadata associated with the corresponding right-of-way;
determine an event occurrence based on image data in the data from one or more of an image capture aerial vehicle or one or more computing devices; and
in response to a determination of a next action for one of the plurality of right-of-way points based on one or more of a capture date or the event occurrence associated with corresponding data, one or more of:
initiate capture of one or more aerial images of the right-of-way,
initiate a biological survey of a portion of the right-of-way, or
initiate vegetation treatment of the portion of the right-of-way.

45-47. (canceled)
